(19) United States
(12) Patent Application Publication
(10) Pub. No.: US 2010/0044426 A1
(43) Pub. Date: Feb. 25, 2010

(54) CASH REGISTER MACHINE

(76) Inventor: Simcha Israel Samuels, Beitar Elite (IL)

Correspondence Address: DANIEL J SWIRSKY, 55 REUVEN ST., BEIT SHEMESH, 99544, IL

(21) Appl. No.: 12/516,198

(22) PCT Filed: Mar. 18, 2008
(86) PCT No.: PCT/IL2008/000372

§ 371 Date: May 24, 2009

Related U.S. Application Data
(60) Provisional application No. 60/895,745, filed on Mar. 20, 2007.

(51) Int. Cl. G07G 1/00

(52) U.S. Cl. 235/23; 235/7 R

(57) ABSTRACT

In one aspect, the present invention is directed to a cash register machine, comprising: an expected currency calculator; and an actual currency calculator, employing one or more sensors for the operation thereof. The sensor(s) may detect whether a banknote is placed into a compartment of the machine, whether a banknote is removed from a compartment of the machine, and so on. According to one embodiment of the invention, the sensors comprise: a first sensor for detecting an operation of placing or removing an object from a compartment of the machine, and a second sensor for determining whether the operation is placing or removing. The machine may further comprise image processing means. The image processing means may be employed for decoding the content of a check, credit card voucher, banknote, and so on.

### FIELD OF THE INVENTION

The present invention relates to the field of cash registers. More particularly, the invention relates to a cash register machine which indicates a discrepancy between the stored cash therein and the registered cash thereof.

### BACKGROUND OF THE INVENTION

The term Cash Register refers in the art to a mechanical or electronic device for calculating and recording sales transactions, and an attached cash drawer for storing currency. The cash register also usually prints a receipt for the customer. This term is referred herein also as Cash Register Machine.

Often cash registers are attached to scales, barcode scanners, checkstands, and debit card or credit card terminals. Today, cash register machines comprise barcode scanner a connection with a database from which they retrieve the price of an item from a database, calculate deductions, tax, differential rates for preferred customers, and so on. In addition they record the form of payment.

It is common to count the currency amount of a cash register as control means. This operation is carried out usually at least once a day; however the necessity to verify a correspondence between the registered currency and the actual currency is acute especially when one cashier replaces another cashier at the same point of sale.

In any case, the operation of counting the cash is time consuming. In the event where one cashier replaces another cashier at a cash register, the required time to count the cash interferes to the clients flow at the line of the point of sale.

It is therefore required a solution which enables to indicate in real time a discrepancy between the registered and real currency of a cash register machine.

Other objects and advantages of the invention will become apparent as the description proceeds.

### SUMMARY OF THE INVENTION

The following embodiments and aspects thereof are described and illustrated in conjunction with systems, tools methods, and so forth, which are meant to be merely illustrative, not limiting in scope.

In one aspect, the present invention is directed to a cash register machine, comprising:
an expected currency calculator; and
an actual currency calculator, employing one or more sensors for the operation thereof.

The sensor(s) may detect whether a banknote is placed into a compartment of the machine, whether a banknote is removed from a compartment of the machine, and so on.

According to one embodiment of the invention, the sensors comprise: a first sensor for detecting an operation of placing or removing an object from a compartment of the machine, and a second sensor for determining whether the operation is placing or removing.

According to one embodiment of the invention, the sensors include a switch sensor for detecting whether a clip of the compartment is lifted up or placed down, and a beam sensor for detecting presence of an object in the beam lane of the beam sensor. The switch sensor may be a switch indicating two states ON and OFF associated with the switch state.

The beam sensor may be based on laser technology, such as a laser beam projector and a laser beam sensor, such as the sensors employed for detecting presence of a passenger in an elevator's door.

The beam sensor may also be based on LED technology, e.g., a LED and optional optical means replaces the laser beam projector.

In one embodiment, one sensor includes a roller, for indicating pulling a banknote from a compartment of the machine. The roller is in contact with the top banknote in a compartment, and the operation of pulling the banknote from the compartment or inserting a banknote into the compartment is determined according to the rolling direction.

In one embodiment, a sensor may detect the type of a coin placed into a compartment of the machine.

According to one embodiment of the invention, one or more of the sensors may include a scale for measuring the weight of the coins in a compartment of the machine.

According to one embodiment of the invention, the sensors may include a barcode reader.

According to one embodiment of the invention, the sensors may include a scanner.

The machine may further comprise image processing means. The image processing means may be employed for decoding the content of a check, credit card voucher, banknote, and so on.

The image processing means may include OCR processing means, pattern recognition means, color composition analyzer, and so on. Each of these mans may be embodied computerized mechanisms, such as software and/or hardware.

According to a further embodiment of the invention, the machine comprises a mechanism for pulling/pushing a banknote into/out of a compartment of the machine, according to expected change in the amount of money in the machine. Such a mechanism may be based on a motor which rotates a roller in a direction corresponding to the operation of inserting/removing a banknote into / from a compartment of the machine.

In addition to the exemplary aspects and embodiments described above, further aspects and embodiments will become apparent by reference to the figures and by study of the following detailed description.

### BRIEF DESCRIPTION OF THE DRAWINGS

The objects and features of the present invention will become apparent from the following detailed description considered in conjunction with the accompanying drawings, in which:

FIG. 1 is a perspective view of a cash register machine, according to one embodiment of the invention.

FIG. 2 is a sectional view which schematically illustrates a deployment of sensors in a banknote compartment, according to one embodiment of the invention.

FIG. 3 is a sectional view which schematically illustrates a deployment of sensors in a banknote compartment, according to another embodiment of the invention.

FIG. 4 is a sectional view which schematically illustrates a deployment of sensors in a coins compartment, according to one embodiment of the invention.

FIG. 5 is a block diagram illustrating the operation of a cash register, according to one embodiment of the invention.

It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, are merely intended to conceptually illustrate the structures and procedures described herein. Reference numerals may be repeated among the figures in order to indicate corresponding or analogous elements.

### DETAILED DESCRIPTION OF PREFERRED EMBODIMENTS

In the following detailed description, numerous specific details are set forth in order to provide a thorough understanding of the invention. However, it will be understood by those skilled in the art that the present invention may be practiced without these specific details. In some instances, well-known methods, procedures, components and circuits have not been described in detail, for the sake of brevity.

In order to overcome on the problems and obstacles of the prior art, according to embodiments of the present invention a cash register machine is provided with a mechanism for detecting whether money (cash, checks, credit card vouchers, etc.) is taken out of or put into the machine, and the amount of currency. Thus, the term “money” refers herein to any form of money, including coins, banknotes, checks, credit card vouchers, and so on.

Nowadays there are several forms of money: coins have been in use for thousands of years, banknotes for hundreds of years, checks and credit card vouchers for tens of years. A recent development of money form introduces an electronic device, such as a smartcard, which acts like a wallet by storing in a memory element the amount of money deposited in the wallet, and the amount of remaining money. Such a device is referred herein as “Electronic Wallet”, although the term Electronic Wallet has a different meaning in the art.

According to embodiments of the present invention, a register machine is provided with means for identifying the amount of currency deposited in the machine.

Coins may be identified by their weight and form. Actually nowadays there are mechanisms that identify coins. Such mechanisms are used in casino houses to detect forgeries of tokens, public telephone devices, and other.

Banknotes, checks, credit card vouchers, etc. can be scanned and identified by image processing such as OCR (Optical Character Recognition), visual characteristics that characterize a banknote (e.g., composition of colors), barcode notation, and so on.

Adding money into a cash register machine is usually carried out upon ending a purchase. At this stage the charge is displayed on the display of the cash register, and the drawer opens, allowing the cashier to add money into the drawer.

Drawing money out of a cash register machine is usually carried out when the cashier has to return change to a client, or when the entire currency content of the cash register machine is taken out, such as at the end of a day.

The drawer comprises a plurality of compartments, an it is common to dedicate each one to a different currency form: coins of the same value (e.g., quarter of Dollar, dimes, etc.), banknotes of the same amount (e.g., 5 Dollars, 10 Dollars, etc.), credit card vouchers, and so on.

Since each compartment comprises content of the same kind, it is possible to use for each compartment sensor(s) for identifying the insertion and removal of items of the same kind into and from a compartment.

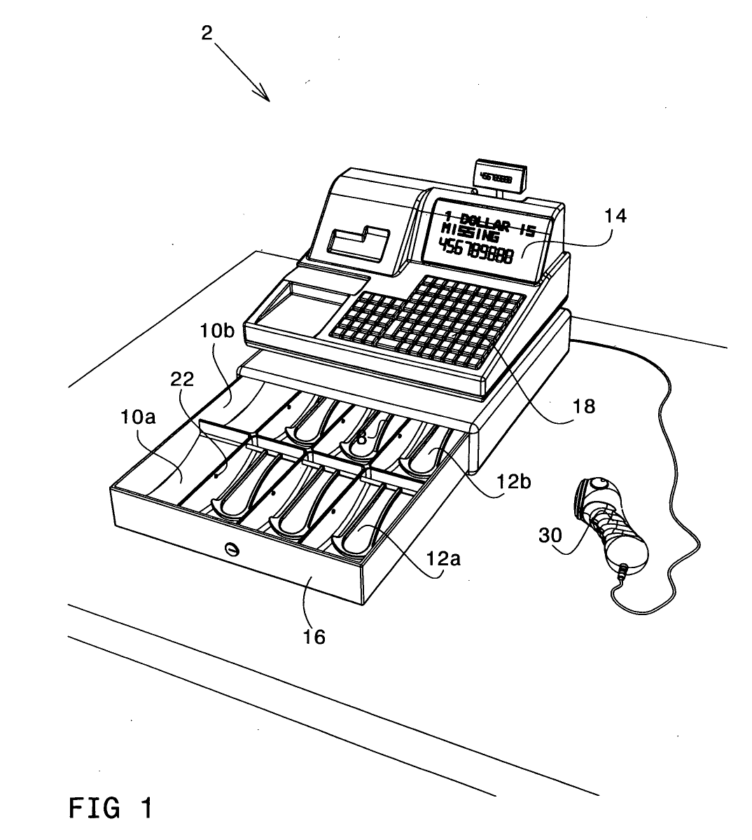

FIG. 1 is a perspective view of a cash register machine, according to one embodiment of the invention.

According to one embodiment of the invention, each compartment comprises sensor(s) for:
detecting an operation of inserting an item into the compartment;
removing an item from the compartment; and
detecting whether the inserted item is of the expected type.

### Counting Sheets of Banknotes

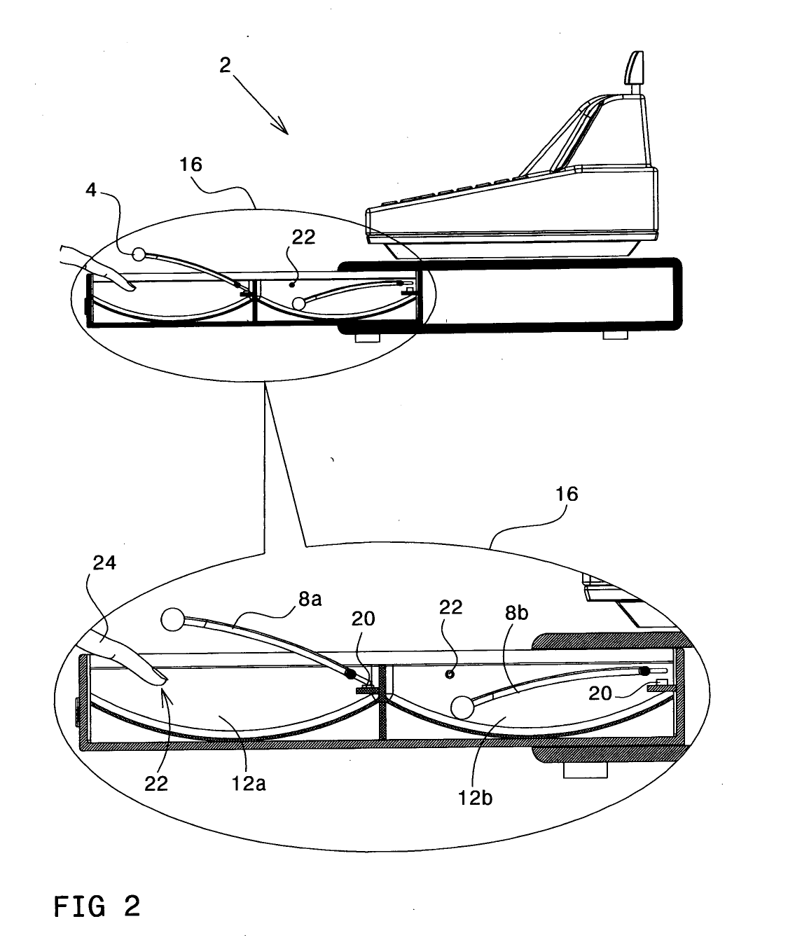

FIG. 2 is a sectional view which schematically illustrates a deployment of sensors in a banknote compartment, according to one embodiment of the invention.

Each of numerals 12a and 12b denotes a banknotes compartment. Two sensors are used for each compartment: an ON/OFF switch sensor 20, and a beam sensor 22.

Sensor 20 is actually is a switch activated by clip 8 of the compartment thereof. An ON state is indicated when clip 8 is lifted up (as the clip of compartment 12a), and an OFF state is indicated when clip 8 is down (as the clip of compartment 12b).

Beam sensor 22 is a sensor which indicates that an object crosses a beam targeted on the sensor. The beam may be a laser beam, a light produced by a LED (Light Emission Diode), and so on. The beam is not shown in the figures herein. Whenever a user enters his hand into a compartment in which a beam sensor is installed, the beam thereof is crossed. This state is detected by sensor 22.

Sensor 22 may also be designed to detect whenever a banknote crosses the beam. In this case the beam should be rendered relatively narrow.

Adding a sheet (banknote) into a compartment requires lifting up clip 8, while taking a sheet out of the compartment can be carried out while clip 8 is down. As such, if beam sensor 22 indicates interference in the beam thereof, if switch 20 indicates that clip 8 is lifted up, it means that a sheet has been added to the compartment thereof, and if clip 8 is down, it indicates that a sheet has been taken out of the compartment. Of course a user has to put the sheets one by one and not a group of sheets.

Additionally or alternatively, a roller sensor 4 may indicate that a sheet is pulled out of a compartment. In this case the roller sensor has to be deployed at the edge of clip 8. If clip 8 is down, the roller rolls if a user pulls a sheet out of the compartment thereof.

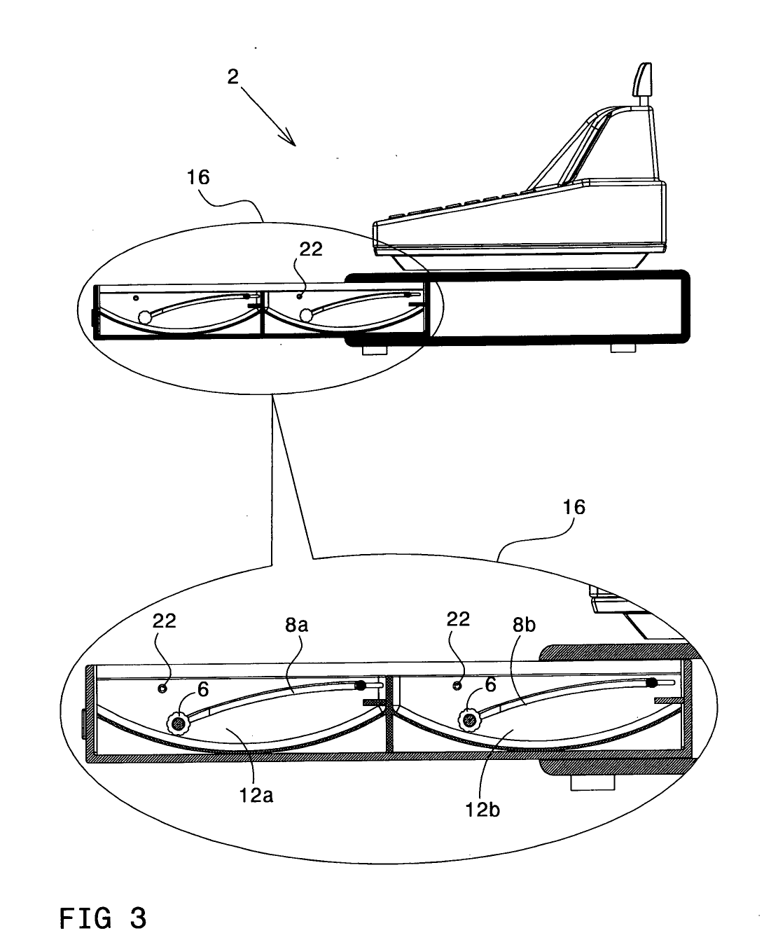

FIG. 3 is a sectional view which schematically illustrates a deployment of sensors in a banknote compartment, according to another embodiment of the invention.

According to this embodiment of the invention, a roller 6 is operated by a motor (not illustrated). Thus, when the cashier thereof enters his hand in the space of banknote compartment 12a for inserting a banknote, sensor 22 detects the presence of the hand in the compartment and as a result the motor activates the rotation of roller 6 in one direction in order to pull the banknote into the compartment. When the cashier enters his hand in the space of banknote compartment 12a for removing one or more banknotes, sensor 22 detects the presence of the hand in the compartment and as a result the motor activates the rotation of roller 6 in the opposite direction in order to push the banknote(s) out of the compartment. An additional sensor (not illustrated) may be employed for counting the number of banknotes.

Of course, the embodiments of FIGS. 2 and 3 are merely examples, and those skilled in the art may introduce more sophisticated solution to the subject of counting the inserted/removed banknotes.

### Counting Coins

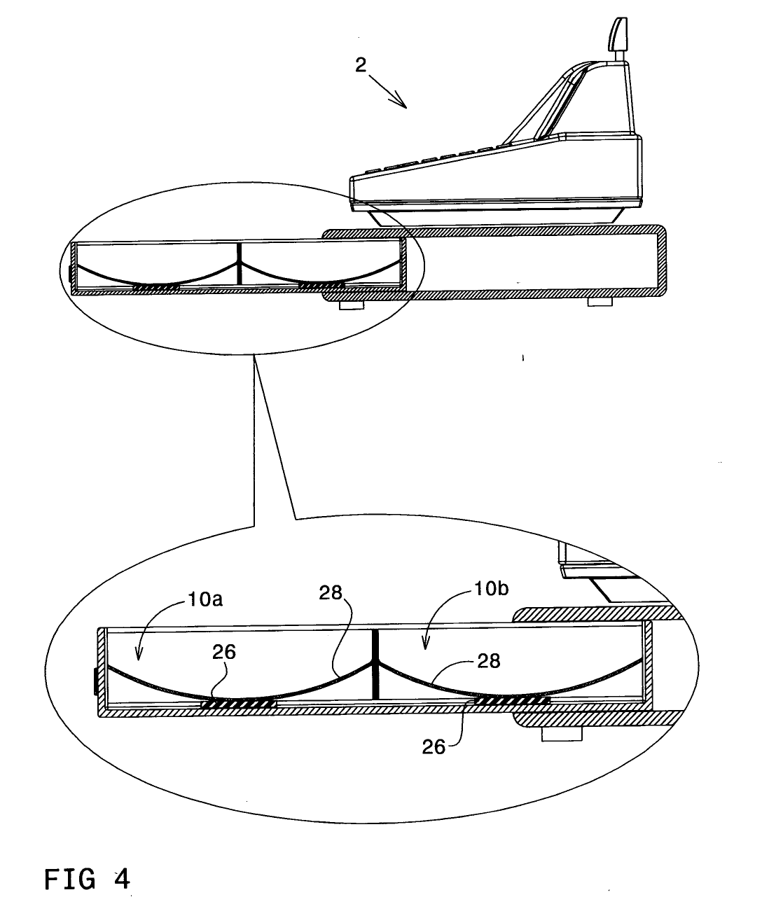

FIG. 4 is a sectional view which schematically illustrates a deployment of sensors in a coins compartment, according to one embodiment of the invention.

Numeral 26 indicates a scale which measures the weight of tray 28. Assuming a compartment comprises coins of the same kind, the number of coins can be calculated by dividing the weight of the coins of a compartment by the weight of a single coin.

### Counting Checks and Credit Cards

The sum of a check can be obtained by manual means, such as typing the amount thereof on the keyboard 14 of the cash register machine. But more likely that the sum of a check is the same as the total sum a user has to pay. Nowadays it is common that the cash register machine types the sum on the check, and all the user has to do is to sign the check. Of course, the content of a check may also obtained by image processing means.

The same stands also for credit card vouchers.

### More Sophisticated Counters

A scanner 30 may be used for scanning checks, credit card vouchers, and so on. The scanned image may be processed by an image processor, which may employ OCR (Optical Character Recognition) means for retrieving the details of the scanned image.

A scanner can be deployed also in a compartment of the cash register machine. Such a scanner may be used also for verifying that a user entered a sheet of the expected kind. For example, indicating that a sheet of $20 has been placed in a compartment dedicated for $5 bills.

A banknote can be identified by the composition of colors thereof, the impressed text, the image thereof, and so on.

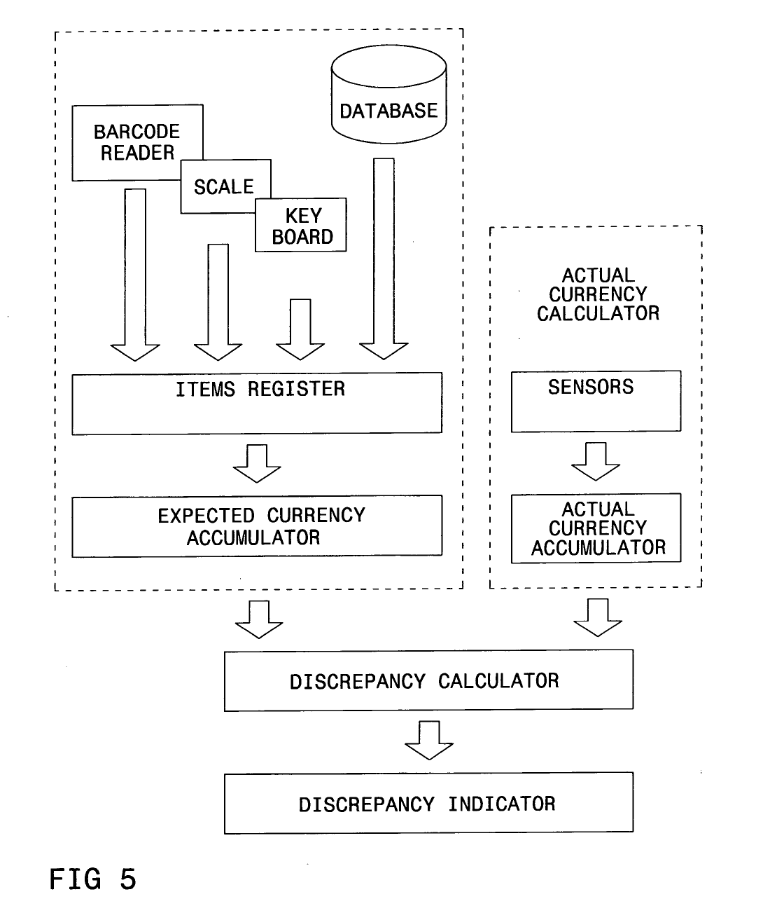

FIG. 5 is a block diagram illustrating the operation of a cash register, according to one embodiment of the invention.

The cash register comprises two main calculating channels: a first channel, in which the expected currency in the cash register is calculated, and a second channel, in which the actual currency in the cash register is calculated.

The expected currency channel operates in the same manner as in the prior art, i.e., accumulating the registered items. The registration process of an item can be carried out by employing a barcode reader for reading the item code of the item, a scale for measuring the weight whenever it is required, a keyboard for typing the item's code whenever it is required (sometimes the barcode reader fails to read the barcode notation), and so forth. The price of an item is retrieved from a database, and the total currency sum is accumulated in an accumulator, which is referred herein as expected currency accumulator.

The actual currency channel, which is the innovative part of the present invention, employs sensors for sensing the currency deposited in and taken out of the cash register machine. The sensed currency amount is accumulated in an accumulator, which is referred herein as actual currency accumulator.

A discrepancy calculator compares between the content of the expected currency accumulator and the actual currency accumulator, and indicates discrepancy if these sums does not correspond.

A discrepancy indicator, such as the screen of the cash register machine, a buzzer, and so on, informs the cashier that the actual currency in the cash register machine does not correspond with the expected currency thereof.

In the figures and description herein, the following numerals have been used:
numeral 2 denotes a cash register machine, according to embodiments of the invention;
numeral 4 denotes a roller sensor;
numeral 6 denotes a roller operated by a motor;
numeral 8 denotes a clip;
numeral 8a denotes a clip of compartment 12a;
numeral 8b denotes a clip of compartment 12b;
numeral 10 denotes a coins compartment;
each of numeral 12a and 12b denotes banknotes compartment;
numeral 14 denotes display;
numeral 16 denotes a drawer;
numeral 18 denotes a keyboard;
numeral 20 denotes a switch sensor;
numeral 22 denotes a beam sensor;
numeral 24 denotes a finger of a user;
numeral 26 denotes a scale;
numeral 28 denotes a tray; and
numeral 30 denotes a scanner.

While certain features of the invention have been illustrated and described herein, the invention can be embodied in other forms, ways, modifications, substitutions, changes, equivalents, and so forth. The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

1. A cash register machine, comprising:
an expected currency calculator;
an actual currency calculator, employing one or more sensors placed at said cash register machine;
a discrepancy calculator, for detecting a discrepancy between excepted currency and actual currency of said cash register machine, said discrepancy calculator being activated upon changing the actual currency of said cash register machine; and
a discrepancy indicator, for displaying an indication of said discrepancy; thereby indicating a discrepancy between the expected and actual currency of said register machine without interrupting the current work with said register machine.

2. A machine according to claim 1, wherein said one or more sensors detect whether a banknote is placed into a compartment of said machine.

3. A machine according to claim 1, wherein said one or more sensors detect whether a banknote is removed from a compartment of said machine.

4. A machine according to claim 1, wherein said one or more sensors comprise a first sensor for detecting an operation of placing or removing an object from a compartment of said machine, and a second sensor for determining whether said operation is placing or removing.

5. A machine according to claim 1, wherein said one or more sensors include a switch sensor for detecting whether a clip of said compartment is lifted up or placed down, and a beam sensor for detecting presence of an object in the beam lane of said beam sensor.

6. A machine according to claim 1, wherein said beam sensor is based on laser technology.

7. A machine according to claim 1, wherein said beam sensor is based on LED technology.

8. A machine according to claim 1, wherein said one or more sensors include a roller, for indicating pulling a banknote from a compartment of said machine.

9. A machine according to claim 1, wherein said one or more sensors include a roller, for indicating inserting a banknote into a compartment of said machine.

10. A machine according to claim 1, wherein said one or more sensors detect the type of a coin placed into a compartment of said machine.

11. A machine according to claim 1, wherein said one or more sensors include a scale for measuring the weight of the coins in a compartment of said machine.

12. A machine according to claim 1, wherein said one or more sensors include a barcode reader.

13. A machine according to claim 1, wherein said one or more sensors include a scanner.

14. A machine according to claim 1, further comprising image processing means.

15. A machine according to claim 14, wherein said image processing means is employed for decoding the content of a member of a group comprising: a check, a credit card voucher, and a banknote.

16. A machine according to claim 14, wherein said image processing means include OCR processing means.

17. A machine according to claim 14, wherein said image processing means include pattern recognition means.

18. A machine according to claim 14, wherein said image processing means include color composition analyzer.

19. A machine according to claim 1, further comprising a mechanism for pulling/pushing a banknote into/out of a compartment of said machine, according to expected change in the amount of money in the machine.

20. A machine according to claim 19, wherein said mechanism is based on a motor which rotates a roller in a direction corresponding to the operation of inserting/removing a banknote into/from a compartment of said machine.

21. A method for presenting the balance of a cash register machine, the method comprising the steps of:
(a) sensing the actual currency in said cash register machine; and
(b) upon detecting a change in the actual currency deposit in said cash register machine:
calculating the expected currency in said cash register machine,
detecting a discrepancy between the actual currency and the expected currency of said cash register machine, and
presenting an indication of said discrepancy.
